(19) United States
(12) Patent Application Publication
(10) Pub. No.: US 2007/0218862 A1
(43) Pub. Date: Sep. 20, 2007

(54) System and method for making measurements in customer devices across different service provider networks

(76) Inventors: Lance A. Tatman, Granite Bay, CA (US); Jerry J. Liu, Sunnyvale, CA (US); Glenn R. Engel, Snohomish, WA (US); Glen L. Purdy JR., Snohomish, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/375,793

(22) Filed: Mar. 14, 2006

(51) Int. Cl. H04Q 7/20; H04M 11/00

(52) U.S. Cl. 455/403

(57) ABSTRACT

In a communication network architecture having multiple service providers over different service areas, a home service provider monitors its customer's experience as the customer roams between technology coverage areas supported by different service providers. An agent, such as software installed on-board the customer's mobile equipment, measures parameters that are related to the service provider and the services it provides, and communicates the measured parameters to the home service provider over the communication network.

### BACKGROUND

The invention relates to the field of telecommunications, and particularly to wireless communication networks. Among other areas, it has applicability to networks such as GPRS and IDEN, and networks according to the IEEE 802.11 standard.

In a typical communications architecture, users are coupled for communication with one or more nodes, such as base stations, servers, etc., which, in turn, are coupled for communication with public communication networks such as the Internet. A given service provider uses its base stations, etc., to support a respective technology coverage area. Communications between such users pass through the service providers' respective base stations, and across the public networks. Such users employ mobile equipment, such as laptop or other portable computers, cellular telephones, etc.

A given service provider (“home service provider”) will provide a respective menu of available services and operating parameters. Within the service provider's technology coverage area, the service provider has access to a lot of data regarding the services provided to its customers. Much of this data will pertain specifically to the service provider, as distinct from other service providers on the network. The service provider accesses the data by monitoring the various system infrastructure components at the base stations and elsewhere in the network.

Service providers conventionally have used specialized test equipment and performed “drive” tests to measure network performance both inside and outside of their respective technology coverage areas. Service providers conduct surveys of their customers to understand, for instance, the level and quality of service available from other service providers outside of the home service provider's technology coverage area. Test labs are also set up to simulate the expected environments. However, these methods have had the drawback that they cannot directly measure customer experience.

This drawback also becomes important as customer equipment gains the capability to “roam,” i.e. to move from place to place, into technology coverage areas that are supported by service providers different from the “home service provider,” that is the service provider with whom the customer subscribes for service. Such other service providers conventionally offer no insight to the home service provider as to the level of service the customer is receiving from other service providers.

For instance, a customer of the service provider might use a GPRS mobile phone that is capable of switching between the home service provider's GPRS network and another service provider's GPRS network. The home service provider's inability to obtain information directly reflective of the system's performance, as the user experiences it, disadvantageously limits the home service provider's ability to provide the customer with effective support. This limited view, also puts the service provider in a difficult situation when selecting other service providers as partners as they have no way of measuring which service provider will provide their customers with the best level of service.

### SUMMARY

The customer's mobile equipment includes an agent, such as a software agent installed on-board the mobile equipment, that measures parameters related to the performance of the mobile equipment in the communication network architecture. The mobile equipment transmits the measured parameters, through the communication network, to the home service provider.

The home service provider thus has direct access to the performance of the system from the customer's perspective, and is able to use that information to improve service to the customer. Service providers can have real-time or near real-time data available to understand their customer's experience, when the customer is mobile to an area supported by another service provider's network technology.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram showing an example of a broadband communications architecture, within which the invention is practiced.

FIG. 2 is a block diagram showing a more detailed implementation of a piece of mobile equipment in accordance with the invention.

FIG. 3 is a flowchart showing operation of a method according to the invention.

FIG. 4 is a flowchart showing operation of a method according to the invention.

### GLOSSARY

For the description of the present invention, the following terms shall have the meanings here set forth:

“Base Station” means a network node, server, etc., generally provided and operated by a service provider, for facilitating user communication over a communication network.

“Customer” means an individual or other party who possesses communication equipment, such as a cell phone or laptop computer, and who subscribes with a service provider for network communication services. The terms “user” and “mobile user” are used interchangeably with “customer.”

“Home service provider” means, with reference to a given customer, a service provider with which the customer has a subscription for network communication service.

“Mobile equipment” means a piece of equipment, owned or possessed by a customer, having capability of communicating over the communication network, and which the customer can, pursuant to the customer's use of the mobile equipment, transport the mobile equipment from place to place and use it in those respective places. The terms “mobile device” and “mobile equipment” are used interchangeably with “mobile equipment.”

“Networking technology” means a communication technology, standard, protocol, format, etc, which a given service provider employs to enable communication over a communication network. Examples of networking technologies include General Packet Radio Service (GPRS) and Integrated Enhanced Digital Network (IDEN).

“Service provider” means a party which maintains equipment and means for transmitting and receiving communications over a communication network, and which offers subscriptions to customers, pursuant to which the customers utilize the service provider's equipment and means for transmitting and receiving, to communicate over the communication network.

“Technology Service Area” means, with reference to a given service provider, a geographical or other area, over which network communication service is provided by the service provider. Typically, communications from customers within the technology service area will be routed through a base station provided and maintained by the given service provider. A given technology service area is characterized in terms of a respective networking technology, that the service provider employs and supports. Generally, a customer's communication equipment will use communication equipment and software that is consistent with the networking technology employed by its home service provider, although the equipment and software may also be able to communicate using other networking technologies.

### DETAILED DESCRIPTION

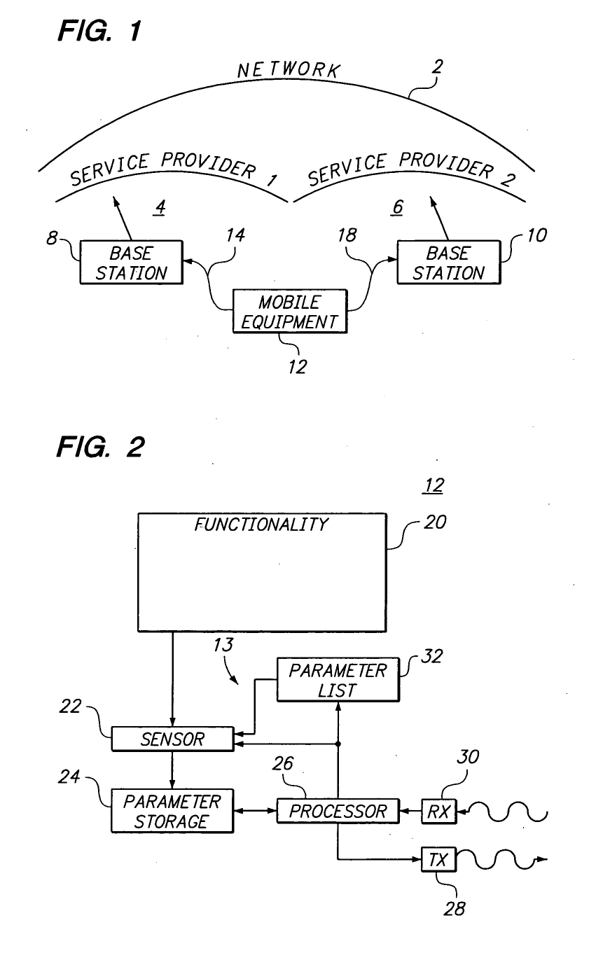

An example of an environment, in which various embodiments of the invention may be practiced, is illustrated by the block diagram of FIG. 1. A communication network 2 covers a region, such as a geographical region, over which first and second service providers provide coverage within respective technology coverage areas 4 and 6. Service provider server equipment, shown as base stations 8 and 10, are provided, within the respective technology coverage areas 4 and 6, to facilitate user communications. Thus, for instance, a customer of the first service provider, while located within the first service provider's technology coverage area 4, communicates with the base station 8 for access to the communication network 2 by means of a wireless or other communication link 14.

For the purpose of describing the invention, the first service provider will be referred to as the “home service provider,” as per the definition in the Glossary, above. The base stations 8 and 10 are shown schematically, but it will be understood that they are implemented differently, as appropriate for different service providers who may offer different technology coverage area technologies, menus of services, available parameters, etc.

The customer employs mobile equipment, generally shown as mobile equipment 12. The mobile equipment 12 includes, among its various possible embodiments, a processor, memory, and a wireless communication interface. For instance, the mobile equipment 12 might include a laptop computer, cell phone, handheld “personal digital assistant” unit, or wireless sensor. As shown, the mobile equipment 12 can move from the home service provider's technology coverage area 4 to the second service provider's technology coverage area 6. When it does so, it will now communicate with the base station 10 of the second service provider, again by means of a wireless or other communication link 18.

The second service provider, who offers service within the technology coverage area 6, may well employ communications technology, services, parameters, etc., different from that of the first service provider. Accordingly, a conventional system, which can only perform drive tests, will provide a severe under-sampling, in both time and space, of the mobile equipment 12's performance.

Also, such conventional methods did not provide measurements from a customer perspective. That is, the measurements that conventionally were available to the home service provider were not necessarily accurately reflective of the performance the mobile equipment 12 actually experienced.

In one embodiment of the invention, measurements are made at the location where the customer is, and at the time when the customer is using the device. The measurements are taken at, or on-board, the mobile equipment 12. Thus, the home service provider has clear visibility of their customer's experience, as the customer moves across service provider networks. As a consequence, a much better representation of customer experience is provided, than with conventional systems, which do not make this available to the service providers.

An embodiment of the invention includes the following:

A. Software agent installed or installable on the customer's mobile equipment.
1. Agent is capable of communicating with a home provider's server.
2. Agent is capable of storing measurements for some period of time.
3. Agent is capable of making measurements useful to the home provider.

B. Server to configure agents and collect data.

FIG. 2 is a block diagram of the piece of mobile equipment 12 of FIG. 1, such as a laptop computer or cell phone, illustrating one embodiment of the agent of the invention.

The mobile equipment 12 has a general functionality 20, whose nature depends on what type of equipment it is. For instance, if the mobile equipment 12 is a laptop computer, its general functionality 20 will include data storage and processing capability, a user interface, etc. A cell phone's general functionality 20 would include voice telecommunications. The embodiment of the invention further includes an agent 13, to be described in detail herebelow.

As the mobile equipment 12 operates, its operating parameters are sensed by a sensor 22, and stored in parameter storage 24. The agent 13 includes a processor 26, which handles the parameters, and transmits them, through a transmit interface 28, over the communication network. The sensor 22 can include a hardware sensor, a software implementation for obtaining the sensed parameter values, or a suitable combination of both.

In another embodiment of the invention, the agent 13 includes the ability to sense the technology employed in the technology coverage area within which the mobile equipment 12 is located. Referring again to FIG. 2, a receive interface 30 receives signals from the network, which can be used to identify the technology employed within the technology coverage area. The signals are provided to the processor 26, which interprets the signals appropriately, to identify the service provider and technology employed. Alternatively, if supported by the mobile equipment 12, the agent 13 could read an API from the mobile equipment 12 which will indicate the current service provider. In either case, the processor 26 then accesses a parameter list 32, which contains sets of parameters that are appropriate for various service provider coverage areas. The processor 26 then configures the sensor 22, to receive the sensed parameter signals that are appropriate for the service provider.

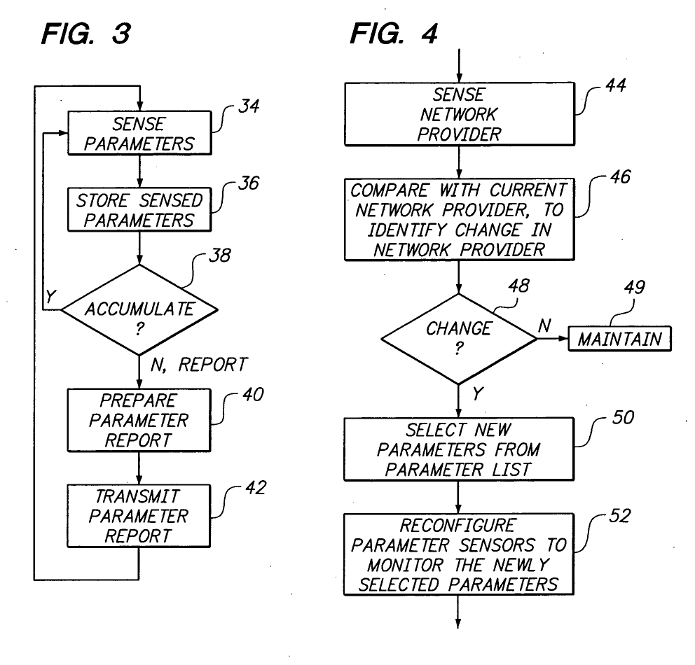

FIG. 3 is a flowchart, showing operation of the agent 13 of the mobile equipment 12. In a step 34, the parameters are sensed (for instance, by the sensor 22). In a step 36, the sensed parameters are stored (for instance, in the parameter storage 24).

While the mobile equipment is in the home service provider's coverage area, sensed parameters from the mobile equipment 12 are reported from the mobile equipment 12 to the home service provider, via its base station 8 and the communication network 2. While the mobile equipment 12 is outside of the home service provider's coverage area, the sensed parameters from the mobile equipment 12 are reported from the mobile equipment 12 to the home service provider, via the equivalent of the base station 8 for the current service provider. In either case, this may be done at specified time intervals, in response to predetermined values of predetermined parameters when the predetermined values are sensed, in response to a request from the home service provider's server equipment, accumulation of a predetermined quantity of parameters, the detection of a change in network technology such as by crossing from one service provider to another, or at other times which the system architect may choose.

For instance, in the implementation of FIG. 3, the parameters are accumulated until one of the above-stated conditions is met. This is tested for, in step 38. If it is not yet time to send the parameter report, then we return to step 34, for additional parameter sensing.

If it is time to send a report, then the agent 13 prepares a parameter report (step 40). Preferably, the processor 26 prepares the parameter report, by following its pre-programmed instructions and/or the agent 13's configuration settings. Preparing the parameter report may include packaging the sensed parameters into a data packet for transmission. pre-processing the parameters, etc. Pre-processing may include summarizing the sensed parameters, calculating statistics, averaging, taking particular note of noteworthy sensed parameter values, etc.

The parameter report is then transmitted (step 42) through the transmit interface 28. In a preferred embodiment, the agent 13 continues sensing the parameters, storing and accumulating the sensed parameters, etc., by looping back to step 34.

FIG. 4 is a flowchart showing additional functionality of the agent 13, to be performed by the mobile equipment 12. FIG. 4 is an embodiment of functionality which allows the mobile equipment 12 to sense information about the service provider, such as changes in the identity of the service provider, as the mobile equipment 12 roams from one service provider's technology coverage area to another's (as shown in FIG. 1). Responsive to the sensed change in service provider, the agent 13 changes the parameters it senses. The agent 13 may also change the frequency of testing.

In step 44, the agent 13 senses the information about the service provider that is providing service in the technology coverage area. This is done by known methods, such as monitoring broadcast signal traffic and analyzing it for content and formats characteristic of a particular network technology supported by a known service provider, receiving and interpreting broadcast transmitter identification signals, etc. Such broadcast signals are received at the receive interface 30, and interpreted by the processor 26 in accordance with its programmed instructions. Alternatively, the agent 13 reads an Application Programming Interface (API) from the mobile equipment 12, to identify the new service provider.

In step 46, the agent 13 uses the sensed service provider information to determine which service provider is providing service in the technology coverage area in which the mobile equipment 12 is currently located. This includes detecting whether, in fact, there is a service provider at all. Preferably, a comparison is done between the currently detected service provider, and the service provider previously detected. If there is no difference (step 48), then the agent 13 maintains the current parameter configuration, and continues to operate as before. If there is a difference, then the agent 13 concludes that the mobile equipment 12 has moved from one service provider's technology coverage area into another service provider's technology coverage area.

The agent 13 then consults the parameter list 32, to determine what parameters are to be sensed and/or changed in the new service provider's technology coverage area (step 50). The agent 13 reconfigures the sensor 22, as appropriate, to begin sensing the parameters that are appropriate for the new service provider's technology coverage area (step 52). In addition to different parameters, the agent 13 may also employ additional code modules that are activated responsive to detection of such new service provider.

In another embodiment, the agent 13 may receive new parameters, new code modules, etc., from outside the mobile equipment 12, such as by receiving suitable communications through the receive interface 30.

Afterwards, the agent 13 resumes sensing parameters. In a preferred embodiment, the agent 13 performs the process of FIG. 3 continuously, as a background or base level task. It executes the process of FIG. 4 according to an appropriate schedule. For instance, the process of FIG. 4 could be executed following step 42 of FIG. 3, before looping back to step 34. Alternatively, FIG. 4 could be called and executed as a subroutine, at regular intervals after an elapsed predetermined time interval. If supported by the mobile equipment 12, the mobile equipment 12 can actively notify the agent 13 that the service provider has changed, via a callback API.

Assuming the home service provider has already installed such software agents on its customers' mobile equipment, the agent 13 can be configured to make measurements continuously at intervals, or do so when the customer uses the device, or when certain conditions are met, e.g. service provider changes. For example, measurements that may be taken by an agent within a GPRS network include, but are not limited to:
Length of time software applications are in the foreground (applications such as a Web browser, an e-mail tool, phone, etc.)
GPRS state
PDP state
TCP Cold Connect time
TCP warm connect time
E-mail one-way delay
WAP and HTML page download time
UDP cold round trip time
UDP warm round trip time
GMS and/or MMS one-way delay
TCP transmit rate
TCP receive rate
Signal strength in dBm
Percentage of battery power remaining
Absolute radio frequency channel number (ARPCN)
Base station identity code (BSIC)
Cell ID
Routing area code (RAC)
Time and/or Date
Geographical Location

Different measurements can be taken, and would be needed for different networking technology. For example, for IDEN networks, the following are examples of measurements that may be taken:
Home Mobile Country Code
Home National Describer Code
International Mobile Equipment Identity
Signal Quality Estimate Level.

As described above, the agent 13 senses the technology being used, and changes the measurements to be appropriate for the new service provider.

As the customer goes about his/her business, the mobile equipment will be taking measurements and either storing them on the device for later transmission to the Operational Support System (OSS) server, or transmitting the measurements at particular intervals, using the network 2 as the communications medium.

As the customer moves out of one service provider's technology coverage area into another, the agent 13 uses the process of FIG. 4 to switch over to make the appropriate measurements for the new service provider. Conventionally, if the mobile equipment 12 roams into another service provider's technology coverage area, the home service provider would normally be blind to the performance the customer is experiencing.

However, because the measurements are being taken from the mobile equipment 12, the customer is independent of the network, and the measurements can be provided back to the home service provider's OSS system. This data may be used by the home service provider for many different applications, such as partner service provider negotiations, verification of network service performance or planning for extension to network coverage.

Because these agents may be employed on a large number of mobile devices, some implementations likely will encounter issues with scaling. Conventionally, installing agents on all of a service provider's customer devices would lead to a solution that could not scale. Also, because the agents will reside on consumer devices, there will be issues with privacy. Systems and methods which include embodiments of the present invention may advantageously address these issues, by employing techniques, such as those disclosed in the patent applications here listed:
Ser. No. 10/047,240 Method and System for Improved Monitoring Measurement and Analysis of Communication Networks Utilizing Dynamically and Remotely Configurable Probes
Ser. No. 10/736,653 Wireless Probe Management System
Ser. No. 11/230,774 Technique for Management Allowing Anonymous Probe Configuration Allowing Anonymous Probe Identity
Ser. No. 11/230,895 Selective Distribution Of Measurement Device Behavior In a Loosely Coupled Autonomous System
Ser. No. 09/884,353 Configuring Devices Using Server Responses
Ser. No. 10/698,292 Bandwidth Management Using Statistical Measurement
Ser. No. 10/306,940 Systems and Methods for Measurement and/or Control Using Mobile Probes
Ser. No. 10/829,091 Methods and devices for configuring mobile applications based on specifications defining regions in multidimensional coordinates.
Ser. No. 09/020,630 Transducers with Electronic Data Sheets That Enable Transducer Access Using Multiple Type of Transducer Object Models
Ser. No. 10/909,051 Method and System for Treating Events and Data Uniformly

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A parameter measurement system, for measuring parameters accessible by mobile equipment which communicates over a communication network, the communication network including first and second technology coverage areas provided by respective first and second service providers, the system comprising:
an agent which includes:
(i) measuring means for measuring predetermined parameters of operation of the mobile equipment and one of the first and second service providers, and for detecting a change of service provider;
(ii) means for changing measurement parameters to make parameter measurements appropriate for a detected change of service provider; and
(iii) a transmitter for transmitting measured parameters over the communication network to the first service provider.

2. A system as recited in claim 1, wherein the mobile equipment includes a processor, memory, and a wireless communication interface.

3. A system as recited in claim 2, wherein the mobile equipment includes one of (i) a cellular telephone, (ii) a portable computer, (iii) a handheld personal digital assistant unit, and (iv) a wireless sensor.

4. A system as recited in claim 1, wherein the agent is included within the mobile equipment.

5. A system as recited in claim 1, wherein the agent includes parameter storage for accumulating measurements of the parameters, and storing the measurements as the measurements accumulate.

6. A system as recited in claim 5, wherein the agent stores the accumulated measurements of the parameters for one of (i) a predetermined period of time, (ii) until a predetermined quantity of parameters have been accumulated, and (iii) until a change in service provider is detected.

7. A system as recited in claim 1, wherein the agent further comprises a processor for preprocessing the measured parameters before transmitting the measured parameters.

8. A system as recited in claim 1, wherein the agent further includes:
(i) a sensor for sensing (a) whether there is a service provider supporting the location where the mobile equipment is located, and (b) if so, information about the service provider that supports the location where the mobile equipment is located, and
(ii) sets of parameters suitable for different service providers, including a parameter set from which parameters are selected for measurement based on the sensed service provider.

9. A system as recited in claim 8, wherein the agent further comprises a transmitter for transmitting the selected parameters over the communication network to the first service provider, responsive to a received request for transmission of the parameters.

10. A system as recited in claim 8, wherein the agent further comprises a selector for selecting parameters for measurement, responsive to one of (i) a received command to do so; and (ii) an elapsed time.

11. A system as recited in claim 1, further comprising a service provider which is coupled for communication with the mobile equipment over the communication network, and which receives the measured parameters.

12. A system as recited in claim 11, wherein the service provider includes a node, coupled to the communication network to receive the measured parameters transmitted from the agent.

13. A method for measuring parameters accessible by mobile equipment which communicates over a communication network, the communication network including first and second technology coverage areas provided by respective first and second service providers, the method comprising:
(i) measuring predetermined parameters of operation of the mobile equipment and one of the first and second service providers, and detecting a change of service provider;
(ii) changing measurement parameters to make parameter measurements appropriate for a detected change of service provider, and
(iii) transmitting measured parameters over the communication network to the first service provider.

14. A method as recited in claim 13, wherein the mobile equipment includes a processor, memory, and a wireless communication interface.

15. A method as recited in claim 14, wherein the mobile equipment includes one of (i) a cellular telephone, (ii) a portable computer, (iii) a handheld personal digital assistant unit, and (iv) a wireless sensor.

16. A method as recited in claim 13, wherein the mobile equipment performs the measuring and the transmitting.

17. A method as recited in claim 13, further comprising accumulating measurements of the parameters, and storing the measurements as the measurements accumulate.

18. A method as recited in claim 17, wherein storing includes storing the accumulated measurements of the parameters for one of (i) a predetermined period of time, (ii) until a predetermined quantity of parameters have been accumulated, and (iii) until a change in service provider is detected.

19. A method as recited in claim 13, further comprising preprocessing the measured parameters, and transmitting the measured and preprocessed parameters.

20. A method as recited in claim 13, wherein the agent further includes:
the method further comprises sensing (a) whether there is a service provider supporting the location where the mobile equipment is located, and (b) if so, sensing information about the service provider that supports the location where the mobile equipment is located;
the mobile equipment includes sets of parameters suitable for different service providers; and
the method further comprises selecting a parameter set, from the sets of parameters, for measurement based on the sensed service provider.

21. A method as recited in claim 20, further comprising transmitting the selected parameters over the communication network, responsive to a received request for transmission of the parameters.

22. A method as recited in claim 20, further comprising selecting parameters for measurement, responsive to one of (i) a received command to do so, and (ii) an elapsed time.

23. A method as recited in claim 13, wherein:
a service provider is coupled for communication with the mobile equipment over the communication network, and
the method further comprises the service provider receiving the measured parameters.

24. A method as recited in claim 23, wherein:
the service provider includes a node, coupled to the communication network; and
the method further comprises the node receiving the measured parameters transmitted from the agent.
